(19) United States
(12) Patent Application Publication
(10) Pub. No.: US 2013/0301790 A1
(43) Pub. Date: Nov. 14, 2013

(54) PRESSURIZED WATER REACTOR WITH REACTOR COOLANT PUMP SYSTEM INLCUDING JET PUMPS

(71) Applicant: Babcock & Wilcox Power Generation Group, Inc., (US)

(72) Inventor: Robert T FORTINO, Canton, OH (US)

(21) Appl. No.: 13/863,427

(22) Filed: Apr. 16, 2013

Related U.S. Application Data
(60) Provisional application No. 61/624,445, filed on Apr. 16, 2012.
(60) Provisional application No. 61/624,966, filed on Apr. 16, 2012.

(51) Int. Cl. G21C 15/25

(52) U.S. Cl. CPC G21C 15/25
USPC 376/392

(57) ABSTRACT

An integral pressurized water reactor (PWR) includes a cylindrical pressure vessel, a cylindrical central riser disposed coaxially inside the cylindrical pressure vessel wherein a downcomer annulus is defined between the cylindrical central riser and the cylindrical pressure vessel, a nuclear core comprising a fissile material, and a steam generator disposed in the downcomer annulus. A reactor coolant pump (RCP) includes a jet pump disposed in the downcomer annulus above or below the steam generator, and a hydraulic pump configured to pump primary coolant into a nozzle of the jet pump. The hydraulic pump includes an electric motor mounted externally on the pressure vessel.

This application claims the benefit of U.S. Provisional Application No. 61/624,445 filed Apr. 16, 2012 and titled “PRESSURIZED WATER REACTOR WITH REACTOR COOLANT PUMP SYSTEM INCLUDING JET PUMPS”. U.S. Provisional Application No. 61/624,445 filed Apr. 16, 2012 and titled “PRESSURIZED WATER REACTOR WITH REACTOR COOLANT PUMP SYSTEM INCLUDING JET PUMPS” is hereby incorporated by reference in its entirety into the specification of this application.

This application claims the benefit of U.S. Provisional Application No. 61/624,966 filed Apr. 16, 2012 and titled “COOLANT PUMP APPARATUSES AND METHODS OF USE FOR SMRS”. U.S. Provisional Application No. 61/624,966 filed Apr. 16, 2012 and titled “COOLANT PUMP APPARATUSES AND METHODS OF USE FOR SMRS” is hereby incorporated by reference in its entirety into the specification of this application.

### BACKGROUND

The following relates to the nuclear reactor arts, nuclear power generation arts, nuclear reactor hydrodynamic design arts, and related arts.

In nuclear reactor designs of the pressurized water reactor (PWR) type, a radioactive nuclear reactor core is immersed in primary coolant water at or near the bottom of a pressure vessel. The primary coolant is maintained in a compressed or subcooled liquid phase. In applications in which steam generation is desired, the primary coolant water is flowed out of the pressure vessel, into an external steam generator where it heats secondary coolant water flowing in a separate secondary coolant path, and back into the pressure vessel. However, this approach has the disadvantage of introducing large-diameter vessel penetrations for flowing primary coolant to and from the steam generator.

An alternative design is an “integral” PWR, in which an internal steam generator is located inside the pressure vessel. In the integral PWR design, the secondary coolant is flowed into the pressure vessel within a separate secondary coolant path in the internal steam generator. Effectively, the large vessel penetrations flowing primary coolant are replaced by typically smaller vessel penetrations for flowing non-radioactive secondary coolant feedwater into the pressure vessel and non-radioactive secondary coolant steam out of the pressure vessel.

The integral PWR design introduces a new issue, namely circulation of the primary coolant. In a conventional (i.e., external steam generator) PWR design, reactor coolant pumps can be located externally to drive primary coolant through the primary coolant circuit between the pressure vessel and the external steam generator. The integral PWR eliminates this external primary coolant flow circuit. Natural primary coolant circulation is not usually sufficient in integral PWR electrical plant designs for reasonably high electrical power output, e.g. of order 100 MW_{elec} or higher. A solution is to provide primary coolant pumps (RCPs) directly pumping the primary coolant in the pressure vessel. Internal RCPs would be convenient, but the difficult thermal, chemical, and radioactive environment inside the pressure vessel makes construction of robust and reliable internal RCPs challenging. External RCPs avoid these difficulties but require vessel penetrations and piping or flanging in order to couple the external RCPs with the primary coolant inside the pressure vessel.

In addition to robustness and reliability of the RCPs, another consideration is effectiveness in providing uniform primary coolant circulation. The RCPs are discrete components each providing localized pumping proximate to the RCP. An assembly of such RCPs provides more uniform circulation, but some flow variation is expected to remain. In practice, the impellers of the RCPs typically generate a large but relatively spatially nonuniform pressure head.

In the case of boiling water reactor (BWR) designs, a known configuration is to employ a jet pump internal to the BWR pressure vessel. In this design, the jet pump is located in the downcomer annulus and discharges into a lower primary coolant inlet that feeds primary coolant to the bottom of the reactor core. The goal is not merely to circulate primary coolant, but to facilitate mixing of primary coolant within the downcomer annulus volume (i.e., recirculation of primary coolant). Toward this end, primary coolant is piped out of the lower end of the downcomer annulus and flowed through external piping back into the pressure vessel at an elevated vessel penetration to feed into the upper suction end of the jet pump. In this design the jet pump has a height that is comparable with the height of the downcomer annulus, and so the mixing chamber of the jet pump mixes primary coolant from the lower end of the downcomer annulus (fed in through the external piping) with primary coolant from the upper end of the downcomer annulus that enters via the suction inlet of the jet pump. Some illustrative examples of BWR designs employing such a recirculating jet pump are described in Roberts, U.S. Pat. No. 3,378,456 (issued Apr. 16, 1968) and Joseph, Int'l Appl. No. WO 2011/035043 A1 (published Mar. 24, 2011).

While providing effective primary coolant recirculation in the BWR context, this design has some disadvantages. The external primary coolant flow circuit presents safety issues and increases cost and hardware. The long jet pump diffuser is also relatively fragile and is prone to cracking due to vibrations, thermal stress, or the like. In an integral PWR design, the internal steam generator is typically located in the downcomer annulus, making it difficult or impossible to also include the recirculating jet pump of the BWR design. Moreover, the goal in a PWR is not recirculation within the downcomer annulus, but rather uniform downward circulation of primary coolant.

Disclosed herein are improvements that provide various benefits that will become apparent to the skilled artisan upon reading the following.

### BRIEF SUMMARY

In one aspect of the disclosure, an apparatus comprises an integral pressurized water reactor (PWR) and a reactor coolant pump (RCP). The integral PWR includes a cylindrical pressure vessel, a cylindrical central riser disposed coaxially inside the cylindrical pressure vessel wherein a downcomer annulus is defined between the cylindrical central riser and the cylindrical pressure vessel, a nuclear core comprising a fissile material, and a steam generator disposed in the downcomer annulus. The RCP includes a jet pump disposed in the downcomer annulus above or below the steam generator, and a hydraulic pump configured to pump primary coolant into a nozzle of the jet pump wherein the hydraulic pump includes an electric motor mounted externally on the pressure vessel.

In another aspect of the disclosure, a reactor coolant pump (RCP) is disclosed for circulating primary coolant in a pressure vessel of containing a nuclear core comprising a fissile material. The RCP includes: a jet pump configured for mounting inside the pressure vessel; and a hydraulic pump including an electric motor configured for mounting to the outside of the pressure vessel wherein the hydraulic pump is configured to pump primary coolant into a nozzle of the jet pump.

In another aspect of the disclosure, an apparatus comprises a jet pump and an annular pump plate to which the jet pump is secured. The annular pump plate is configured to be secured within a downcomer annulus of a pressure vessel of a nuclear reactor. In some embodiments, the annular pump plate defines an annular flow distribution plenum in fluid communication with a suction inlet of the jet pump. In some embodiments, the pump plate includes a mounting opening passing through the annular pump plate and in which the jet pump is secured, and the apparatus further comprises: a compression ring compressed between the jet pump and a perimeter of the mounting opening to seal the mounting opening; and fasteners securing the jet pump to the annular pump plate wherein the fasteners are accessible from a first side of the annular pump plate, with no fasteners securing the jet pump to the annular plate that are not accessible from the first side of the pump plate.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows a nuclear reactor including reactor coolant pumps (RCPs) comprising jet pumps driven by hydraulic pumps with externally mounted motors as disclosed herein.

FIG. 2 diagrammatically shows a perspective isolation view of one of the electrically driven hydraulic pumps of FIG. 1.

FIG. 3 diagrammatically shows a perspective view in partial section of the electrically driven hydraulic pumps of FIG. 1 mounted on the outside of the pressure vessel, including a sectional view of the fluid coupling between a hydraulic pump and a jet pump.

FIG. 4 diagrammatically shows a perspective view of a portion of the annular pump plate of FIG. 1 with four mounted jet pumps.

FIG. 5 shows an exploded view of one of the toroidal headers.

FIG. 6 shows a perspective view of one of the jet pumps (with the nozzle omitted).

FIG. 7 diagrammatically shows a side sectional view of one of the jet pumps including annotated indications of the various primary coolant flows.

FIG. 8 diagrammatically shows a removable assembled unit including the jet pumps, the pump plate, the toroidal headers, and the cylindrical central riser including an upper shroud support ring.

FIG. 9 shows an arcuate pump plate segment.

FIG. 10 shows a lower element of the pump plate segment of FIG. 10.

FIG. 11 diagrammatically shows a side sectional view of two jet pumps of a second, two-stage embodiment including annotated indications of the various primary coolant flows.

FIG. 12 diagrammatically shows a perspective view of the integral element including the conical members of the two-stage jet pumps of FIG. 11.

FIG. 13 diagrammatically shows a side view of the diffuser of one of the two-stage jet pumps of FIG. 11.

FIG. 14 diagrammatically shows a perspective view in partial section of the two-stage jet pumps of FIG. 11 mounted on the pump plate of FIGS. 9 and 10.

FIG. 15 diagrammatically shows another perspective view of the two-stage jet pumps of FIG. 11 mounted on the pump plate of FIGS. 9 and 10.

FIG. 16 shows an exploded view of one of the toroidal headers of the embodiment of FIGS. 14 and 15.

FIG. 17 diagrammatically plots expected discharge flow velocities as a function of radial position for the two-stage jet pumps of FIG. 11.

FIG. 18 diagrammatically shows a perspective view in partial section of an alternative hydraulic pump.

FIG. 19 diagrammatically shows a perspective view of single-stage jet pumps including a suitable toroidal header including a centrifugal pump for pressurizing the nozzles of the jet pumps.

FIG. 20 diagrammatically shows a removable assembled unit including the jet pumps, the pump plate, the toroidal headers of FIG. 19, and the cylindrical central riser including an upper shroud support ring.

FIG. 21 diagrammatically shows a side sectional view of one of the toroidal headers of FIG. 19.

FIG. 22 shows a perspective sectional view of one of the toroidal headers of FIG. 19.

FIG. 23 shows a perspective view of the impeller of the hydraulic pump of FIGS. 18-22.

FIG. 24 diagrammatically shows a perspective view of a toroidal header with separable nozzle arms that is suitably substituted for the toroidal header with integral nozzle arms of FIG. 5.

FIG. 25 diagrammatically shows an exploded perspective view of the main outer housing of the toroidal header of FIG. 24.

### DETAILED DESCRIPTION OF THE PREFERRED EMBODIMENTS

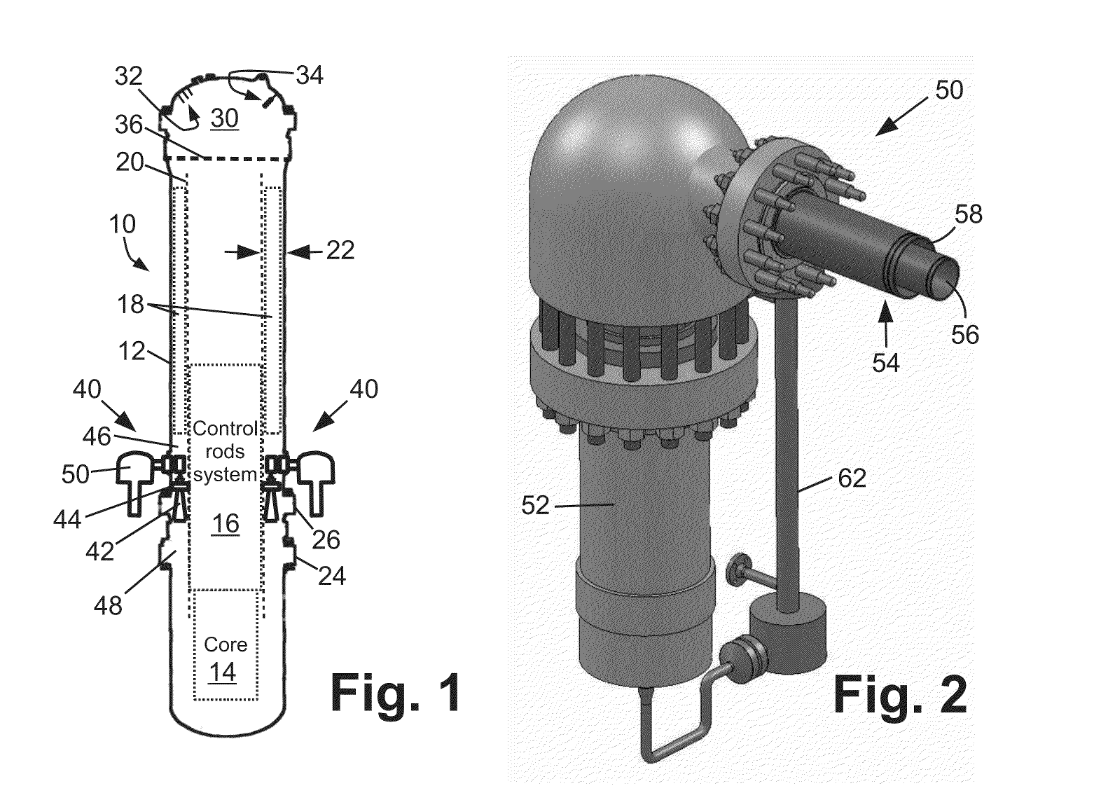

With reference to FIG. 1, an illustrative nuclear reactor of the pressurized water reactor (PWR) type 10 includes a pressure vessel 12, which in the illustrative embodiment is a cylindrical vertically mounted vessel. As used herein, the phrase “cylindrical pressure vessel” or similar phraseology indicates that the pressure vessel has a generally cylindrical shape, but may in some embodiments deviate from a mathematically perfect cylinder. For example, the illustrative cylindrical pressure vessel 12 has a circular cross-section of varying diameter along the length of the cylinder, and has rounded ends, and includes various vessel penetrations, vessel section flange connections, and so forth. Similarly, although the pressure vessel 12 is upright, it is contemplated for this upright position to deviate from exact vertical orientation of the cylinder axis. For example, if the PWR is disposed in a maritime vessel then it may be upright but with some tilt, which may vary with time, due to movement of the maritime vessel on or beneath the water.

Selected components of the PWR that are internal to the pressure vessel 12 are shown diagrammatically in phantom (that is, by dotted lines). A nuclear reactor core 14 is disposed in a lower portion of the pressure vessel 12. The reactor core 14 includes a mass of fissile material, such as a material containing uranium oxide (UO₂) that is enriched in the fissile ²³⁵U isotope, in a suitable matrix material. In a typical configuration, the fissile material is arranged as “fuel rods” arranged in a core basket. The pressure vessel 12 contains primary coolant water (typically light water, that is, H₂O, although heavy water, that is, D₂O, is also contemplated) in a subcooled state.

A control rods system 16 is mounted above the reactor core 14 and includes control rod drive mechanism (CRDM) units and control rod guide structures configured to precisely and controllably insert or withdraw control rods into or out of the reactor core 14. The illustrative control rods system 16 employs internal CRDM units that are disposed inside the pressure vessel 12. Some illustrative examples of suitable internal CRDM designs include: Stambaugh et al., “Control Rod Drive Mechanism for Nuclear Reactor”, U.S. Pub. No. 2010/0316177 A1 published Dec. 16, 2010 which is incorporated herein by reference in its entirety; and Stambaugh et al., “Control Rod Drive Mechanism for Nuclear Reactor”, Int'l Pub. WO 2010/144563 A1 published Dec. 16, 2010 which is incorporated herein by reference in its entirety. In general, the control rods contain neutron absorbing material, and reactivity is increased by withdrawing the control rods or decreased by inserting the control rods. So-called “gray” control rods are continuously adjustable to provide incremental adjustments of the reactivity. So-called “shutdown” control rods are designed to be inserted as quickly as feasible into the reactor core to shut down the nuclear reaction in the event of an emergency. Various hybrid control rod designs are also known. For example, a gray rod may include a mechanism for releasing the control rod in an emergency so that it falls into the reactor core 14 thus implementing a shutdown rod functionality. Internal CRDM designs have advantages in terms of compactness and reduction in mechanical penetrations of the pressure vessel 12; however, it is also contemplated to employ a control rods system including external CRDM located outside of (e.g., above) the pressure vessel and operatively connected with the control rods by connecting rods that pass through suitable mechanical penetrations into the pressure vessel.

The illustrative PWR 10 is an integral PWR, and includes an internal steam generator (or set of internal steam generators) 18 disposed inside the pressure vessel 12. In the illustrative configuration, a central riser 20 is a cylindrical element disposed coaxially inside the cylindrical pressure vessel 12. (Again, the term “cylindrical” is “cylindrical” is intended to encompass generally cylindrical risers that deviate from a perfect cylinder by variations in diameter along the cylinder axis, inclusion of selected openings, or so forth). The riser 20 surrounds the control rods system 16 and extends upward, such that primary coolant water heated by the operating nuclear reactor core 14 rises upward through the central riser 20 toward the top of the pressure vessel, where it discharges, reverses flow direction and flows downward through an outer annulus defined between the central riser 20 and the cylindrical wall of the pressure vessel 12. The illustrative steam generator 18 is an annular steam generator (or annular set of steam generators) disposed in a downcomer annulus 22 defined between the central riser 20 and the wall of the pressure vessel 12. The steam generator 18 provides independent but proximate flow paths for downwardly flowing primary coolant and upwardly flowing secondary coolant. The secondary coolant enters at a feedwater inlet 24, flows upward through the steam generator 18 where it is heated by the proximate downwardly flowing primary coolant to be converted to steam, and the steam discharges at a steam outlet 26.

FIG. 1 does not illustrate the detailed structure of the steam generator 18 or the secondary coolant flow path. For example, feedwater inlet tubes and/or a feedwater plenum convey feedwater from the inlet 24 to the bottom of the steam generator 18, and steam outlet tubes and/or a steam plenum convey steam from the top of the steam generator 18 to the steam outlet 26. Typically, the steam generator comprises steam generator tubes and a surrounding volume (or “shell”) containing the tubes, thus providing two proximate flow paths that are in fluid isolation from each other. In some embodiments, the primary coolant flows downward through the steam generator tubes (that is, “tube-side”) while the secondary coolant flows upward through the surrounding volume (that is, “shell-side”). In other embodiments, the primary coolant flows downward through the surrounding volume (shell-side) while the secondary coolant flows upward through the steam generator tubes (tube-side). In either configuration, the steam generator tubes can have various geometries, such as vertical straight tubes (sometimes referred to as a straight-tube once-through steam generator or “OTSG”), helical tubes encircling the central riser 20 (some embodiments of which are described, by way of illustrative example, in Thome et al., “Integral Helical Coil Pressurized Water Nuclear Reactor”, U.S. Pub. No. 2010/0316181 A1 published Dec. 16, 2010 which is incorporated herein by reference in its entirety), or so forth.

The pressure vessel 12 defines a sealed volume that, when the PWR is operational, contains primary coolant water in a subcooled state. Toward this end, the PWR includes an internal pressurizer volume 30 disposed at the top of the pressure vessel 12 containing a steam bubble whose pressure controls the pressure of the primary coolant water in the pressure vessel 12. The pressure is controlled by suitable devices such as a heater 32 (e.g., one or more resistive heaters) that heats the steam to increase pressure, and/or a sparger 34 that injects cool water or steam into the steam bubble to reduce pressure. A baffle plate 36 separates the internal pressurizer volume 30 from the remainder of the sealed volume of the pressure vessel 10. By way of illustrative example, in some embodiments the primary coolant pressure in the sealed volume of the pressure vessel 12 is at a pressure of about 2000 psia and at a temperature of about 300° C. (cold leg just prior to flowing into the reactor core 14) to 320° C. (hot leg just after discharge from the reactor core 14). These are merely illustrative subcooled conditions, and a diverse range of other operating pressures and temperatures are also contemplated. Moreover, the illustrative internal pressurizer can be replaced by an external pressurizer connected with the pressure vessel by suitable piping or other fluid connections.

A set of reactor coolant pumps (RCPs) 40 is configured to drive circulation of primary coolant water in the pressure vessel 12. Each RCP 40 comprises one or more jet pumps 42 disposed in the pressure vessel 12. The jet pumps are mounted on an annular pump plate 44 that separates the suction side 46 of the jet pumps 42 from the discharge side 48 of the jet pumps 42. The jet pumps 42 employ primary coolant water accelerated by one or more electrically driven hydraulic pumps 50 as the motive fluid that is accelerated to create a low pressure region that draws additional primary coolant through a suction inlet into the jet pump 42. The hydraulic pumps 50 can be substantially any type of electrically driven pump. Advantageously, the electric motors of the hydraulic pumps 50 are mounted externally on the pressure vessel 12 so that they are not exposed to the difficult environment inside the pressure vessel 12. The external motor arrangement also greatly simplifies electrical connection.

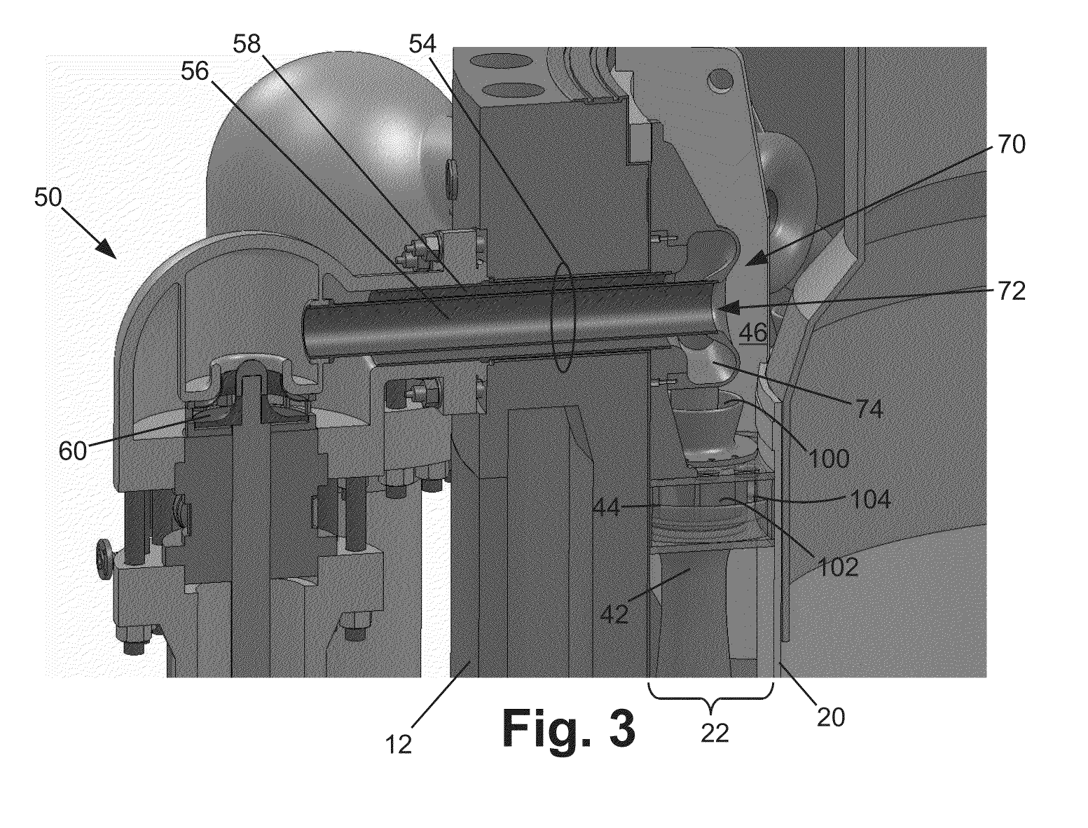

With reference to FIGS. 2 and 3, the hydraulic pump 50 can be substantially any type of electrically driven fluid pump, such as a glandless canned motor pump with a pump motor 52 having a vertical orientation (as shown) or having a horizontal orientation. In the illustrative example, the pump head includes a coaxial connector 54 having an inner conduit 56 connected with the suction side of the hydraulic pump 50 and an outer conduit 58 surrounding the inner conduit 56 and connecting with the discharge side of the hydraulic pump 50. The illustrative hydraulic pump 50 further includes an impeller 60 (see FIG. 3). The hydraulic pump 50, including the electric motor 52 and the impeller 60, is mounted as a unit externally on the pressure vessel 12, as seen in FIG. 3. The illustrative hydraulic pump 50 further includes a heat exchanger 62 for cooling the pump; however, as the pump is mounted externally it is not exposed to the heat inside the pressure vessel and accordingly in some embodiments the heat exchanger is omitted or is replaced by air cooling or another heat removal configuration.

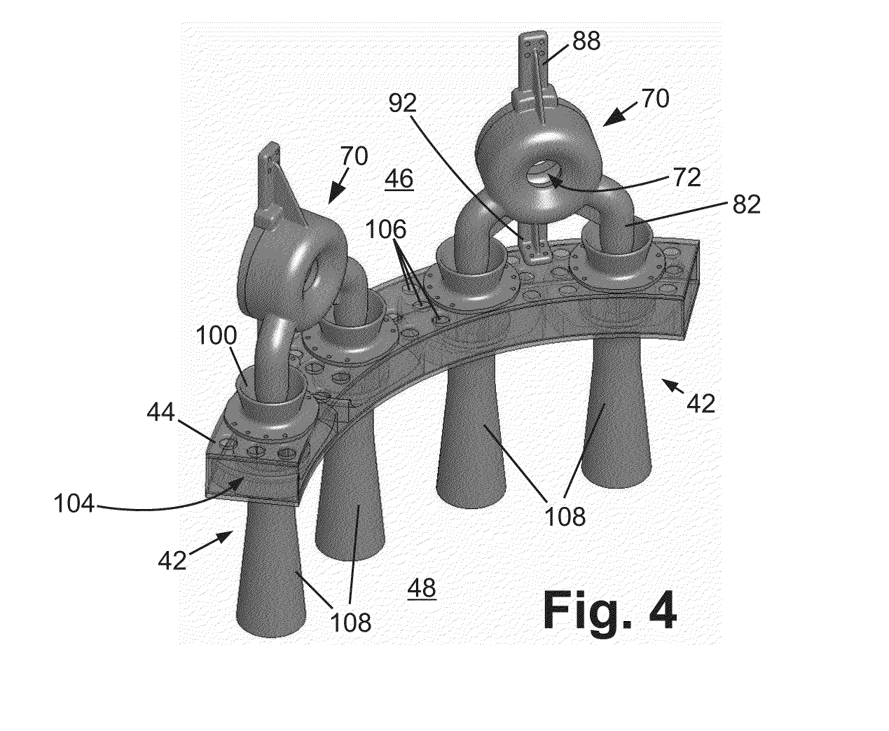

With continuing reference to FIG. 3 and with further reference to FIG. 4, the coaxial connector 54 passes through a vessel penetration of the pressure vessel 12 and terminates in a toroidal header 70. This configuration entails only one circular hole (i.e., vessel penetration) in the reactor vessel 12 for both the pump inlet and outlet. The head of the external hydraulic pump 50 optionally encloses the coaxial line 54 so that external piping is not present, thus reducing the possibility of a small break loss-of-coolant accident (LOCA). The torus header 70 has a central opening 72 in fluid communication with the inner conduit 56 of the coaxial connector 54 that couples the suction side of the hydraulic pump 50 with the downcomer annulus 22 on the suction side 46 of the jet pump 42. The outer conduit 58 of the coaxial connector 54 delivers the pump discharge into an outer toroidal plenum 74 of the toroidal header 70 that surrounds the central opening 72. The impellor 60 of the hydraulic pump 50 pressurizes and discharges primary coolant received via the central opening 72 and inner conduit 56 into the outer conduit 58 which in turn pressurizes the toroidal plenum 74 of the toroidal header 70.

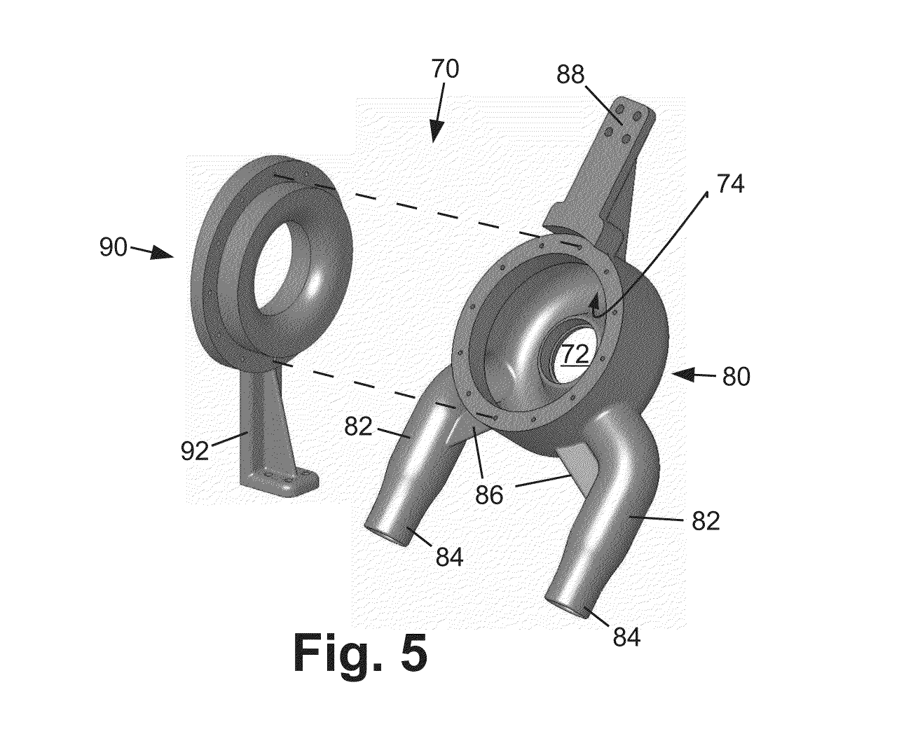

With reference to FIG. 5, a suitable assembly forming the toroidal header 70 is shown. A main outer housing 80 has two integrally formed jet pump nozzles arms 82 each terminating in a nozzle 84 that drives a jet pump. Thus, each toroidal header 70 is configured to drive two jet pumps 42. (More generally, each toroidal header may be configured to drive one, two, three, or more jet pumps.) The nozzles 84 are in fluid communication with the toroidal plenum 74 (and hence with the discharge side of the hydraulic pump 50) via the nozzle arms 82. Optional gussets 86 are provided on the bottom of the arms 82 to strengthen the assembly and to reinforce the arms to prevent fatigue cracking. An upper bracket 88 is provided on the main housing 80 for attachment to the pressure vessel 12 (e.g., attaching to an upper shroud support ring or other attachment point on or associated with the pressure vessel). The front of the main housing 80 provides a slip fit with the inner pipe of the coaxial connector 54, and may optionally include an o-ring, gasket, or other sealing element (not shown). The toroidal header 70 further includes a backplate 90 that engages the main outer housing 80. The illustrative back plate 90 includes a lower bracket 92 which attaches to the top of the pump plate 44 (see FIG. 4). The back plate 90 has a slip fit with the outer pipe of the coaxial connector 54, which may optionally include o-rings, gaskets, or so forth.

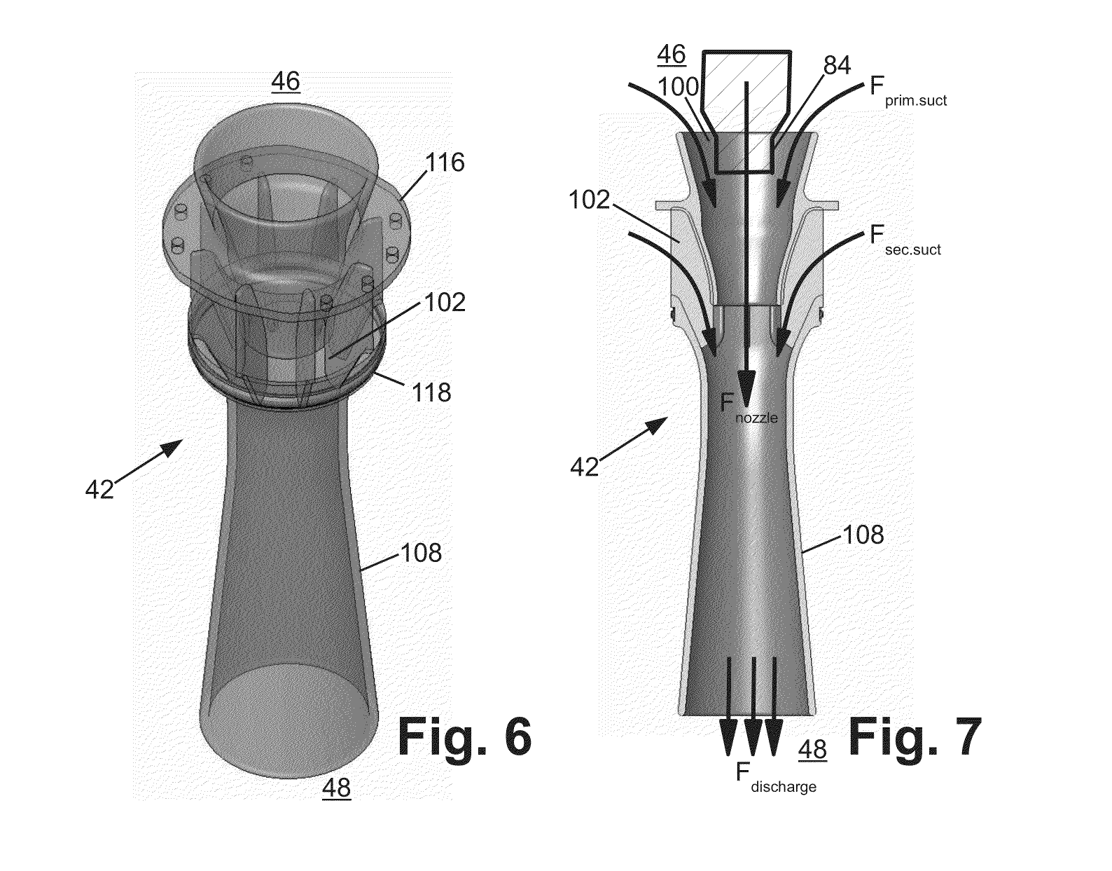

With continuing reference to FIGS. 3 and 4 and with further reference to FIGS. 6 and 7, the illustrative jet pumps 42 are single-stage jet pumps in that there is only one nozzle 84; however, each jet pump 42 includes two suction inlets 100, 102 (see FIG. 7). The first suction inlet 100 is defined by an annular gap between the nozzle 84 and an inlet opening of the jet pump 42. The second suction inlet 102 is an annular opening that is spanned by fixed vanes and is located partway down the body of the jet pump 42. In conjunction with the two suction inlets 100, 102, the illustrative pump plate 44 defines an annular flow distribution plenum 104 (also referred to herein as a “manifold box”) which is in fluid communication with the suction side 46 of the jet pumps 42 via openings 106 and in fluid communication with a second suction inlet 102 of the jet pump 42. The jet pump also includes a diffuser 108 located below the second suction inlet 102 and below the pump plate 44.

The jet pump 42 can be considered to be a single-stage jet pump with dual suction flow. With particular reference to FIG. 7, in operation the electrically driven hydraulic pump 50 delivers primary coolant under pressure to the nozzle 84 generating a nozzle flow (F_{nozzle}) flowing through the jet pump 42. The nozzle flow (F_{nozzle}) entrains primary suction flow (F_{prim.suct}) drawn from the suction side 46 into the jet pump 42 through the first suction inlet 100. The nozzle flow (F_{nozzle}) also entrains secondary suction flow (F_{sec.suct}) drawn from the annular flow distribution plenum 104 into the jet pump 42 through the second suction inlet 102. These primary flows (F_{nozzle}, F_{prim.suct}, F_{sec.suct}) mix together inside the diffuser 108 and discharge from the diffuser 108 as jet pump discharge flow (F_{discharge}). The overall effect is to convert the relatively higher pressure but low flow rate nozzle flow (F_{nozzle}) into a relatively lower pressure but higher flow rate discharge flow (F_{discharge}). The jet pump 42 thus operates as a pressure-to-flow transformer.

The single-stage dual suction jet pump 42 is an illustrative example. In an alternate configuration the conical suction inlet 100 is omitted, and the nozzle 84 connects in sealed fashion with the lower portion of the jet pump 42. In this case, the jet pump would be single-stage with a single suction inlet, namely suction inlet 102 drawing primary coolant from the annular flow distribution plenum 104. In a different alternative embodiment, the first suction inlet 100 is retained substantially as shown in FIGS. 3, 4, and 7, but the second suction inlet 102 is omitted. In this case the annular flow distribution plenum 104 would also suitably be omitted and the pump plate would be a single horizontal circumferential plate with no plenum and without the openings 106.

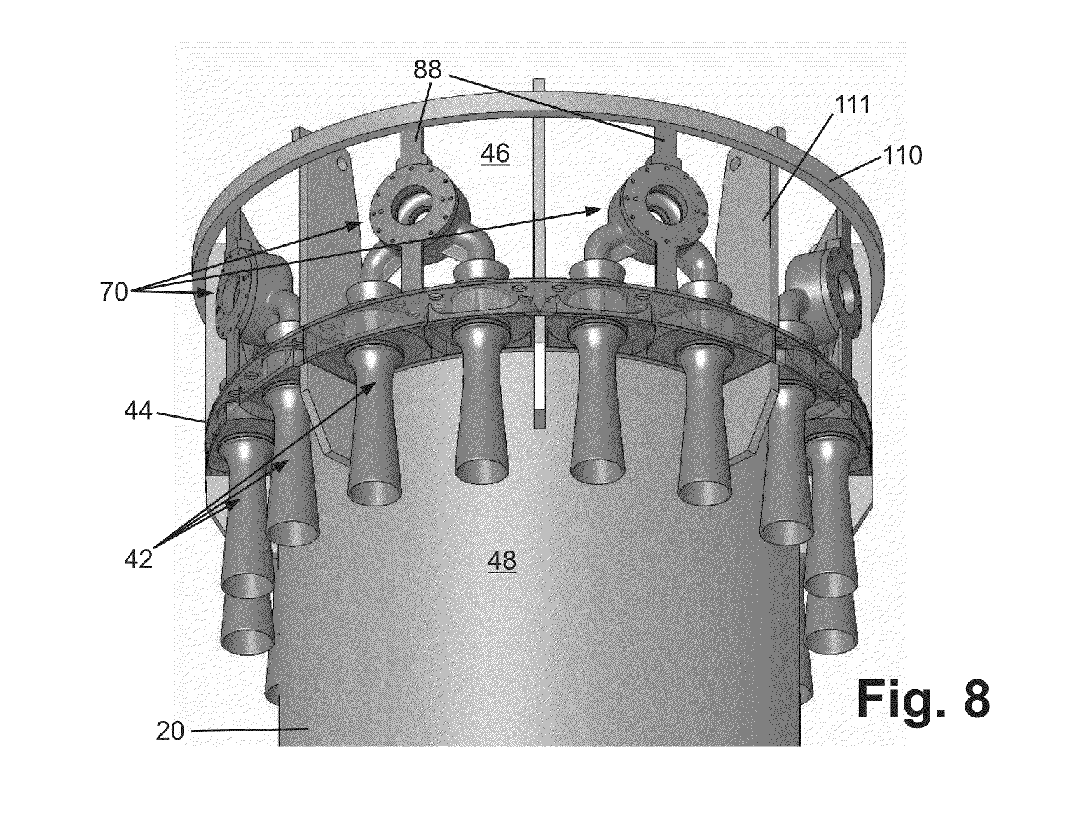

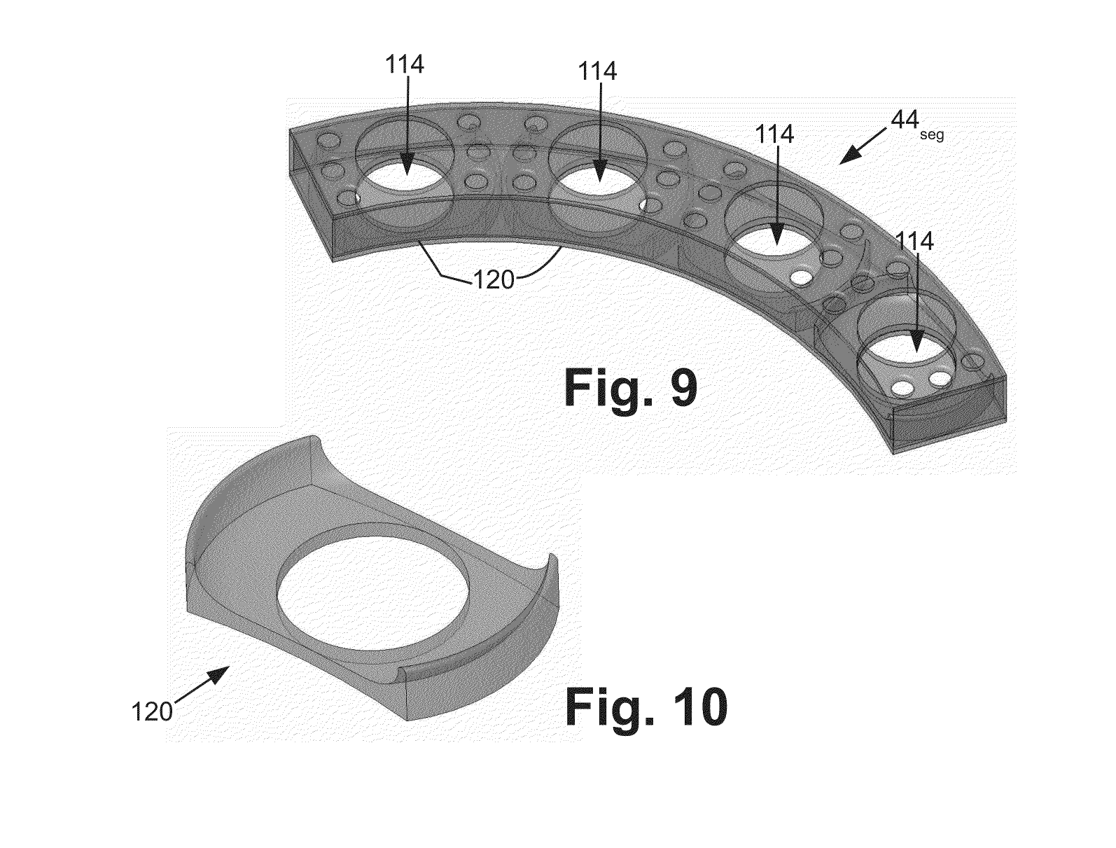

With reference to FIGS. 3-7 and further reference to FIGS. 8-10, assembly and maintenance aspects are next addressed. FIG. 8 shows the upper portion of the central riser 20 (which defines the innermost extent of the downcomer annulus) with the pump plate 44 forming an annular element (or annular assembly of constituent arcuate elements) supporting the jet pumps 42. The toroidal headers 70 are also shown, with their upper brackets 88 secured to an upper shroud support ring 110 that in turn engages the pressure vessel 12 (attachment not shown in FIG. 8). FIG. 9 shows an arcuate pump plate segment 44_{seg} (an assembly of such pump plate segments suitably forms the complete pump plate 44). This segmented construction of the annular pump plate 44 is convenient if the annulus is interrupted by gussets 111 connecting the support ring 110 with the riser 20, as shown in FIG. 8. In this embodiment the tapered ends of the gussets 111 guide the pump plate 44 into the reactor vessel. Each pump plate segment 44_{seg} defines a compartmentalized portion of the overall annular flow distribution plenum 104. The arcuate pump plate segment 44_{seg} includes four pump mounting openings 114 passing through the annular pump plate 44 for mounting four jet pumps 42. In some embodiments the jet pumps 42 are mounted in a fashion that enables installation and/or removal from one side (the suction side 46 in the illustrative embodiment). Toward this end, the jet pump 42 includes a mounting flange 116 (see FIG. 6) that is secured to the top of the pump plate 44 via suitable fasteners, and a compression ring 118 (see FIG. 6) such as an o-ring or gasket that is compressed between the jet pump 42 and a perimeter of the mounting opening 114 to seal the mounting opening. To ensure a good seal, the perimeter of the mounting opening 114 against which the compression ring 118 engages may be a separately manufactured and welded element 120 (see FIG. 10). The illustrative element 120 has a dish shape to guide primary coolant flow in the distribution plenum 104 into the second suction inlet 102 of the jet pump 42. An inner edge of the element 120 protrudes slightly into the plenum 104 to engage the seal ring 118 shown in FIG. 6. In this way, the jet pump 42 is secured to the annular pump plate 44 by fasteners that are accessible from the suction side 46 of the jet pump 42 and is not secured to the annular pump plate 44 by any fasteners that are not accessible from the suction side 46 of the jet pump 42. The jet pumps 42 with torus heads 70 are removable from the top (i.e. suction side 46) individually, or the entire assembly (jet pumps 42, toroidal headers 70, central riser 20, and pump plate 44 as shown in FIG. 8) can be removed as an assembled unit. The entire assembly would usually only be removed for inspection of the reactor vessel at intervals longer than the refueling cycle. Alternatively, one or more jet pumps can be removed and the reactor vessel inspected remotely using the opening or openings 114 in the pump plate 44 as pass-throughs or viewing openings for the inspection probes.

In the illustrative example of FIGS. 2-10, each toroidal header 70 is pressurized by one hydraulic pump 50 and drives two jet pumps 42 via the two nozzle arms 82. Thus, the number of hydraulic pumps is one-half the number of jet pumps. Different hydraulic pump/jet pump ratios can be employed by having one, two, three, or more nozzles driven by a single hydraulic pump. In overall operation, the RCP 40 provides a pressure head-to-primary coolant flow transformation in which a relatively higher head but lower flow output of the hydraulic pump 50 is converted by the jet pumps 42 to a relatively lower head but higher flow output for circulating the primary coolant in the pressure vessel.

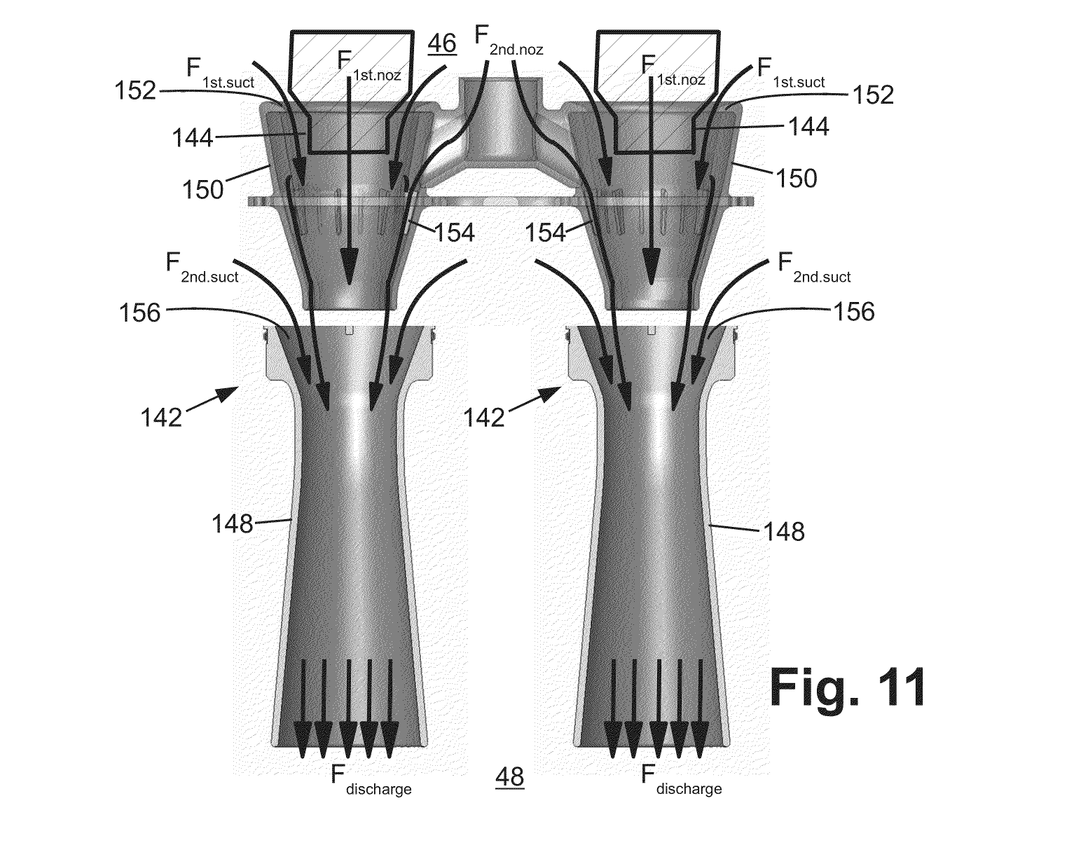

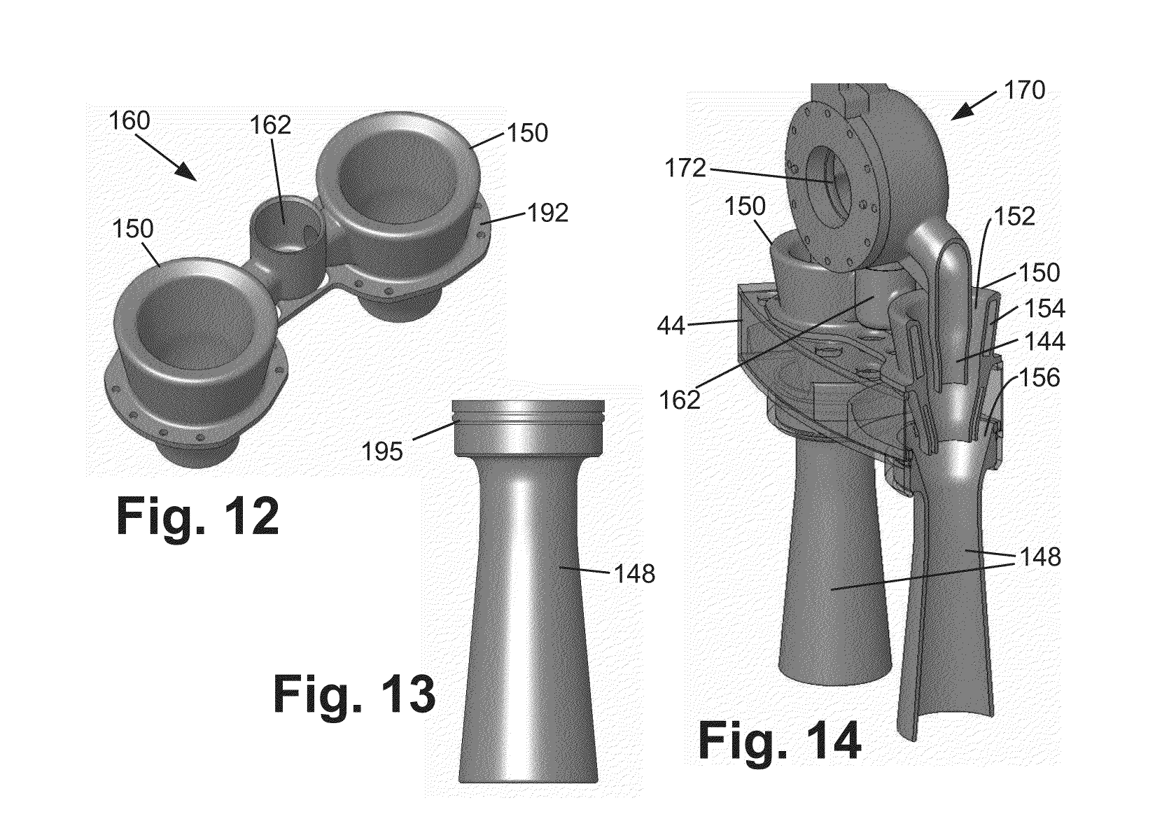

With reference to FIGS. 11-16, an embodiment is disclosed that employs two-stage jet pumps 142. As shown in FIG. 11, each two-stage jet pump 142 includes a nozzle 144 and a diffuser 148 (see also FIG. 13) that are analogous to the nozzle 84 and diffuser 108 of the single-stage jet pump 42. However, the two-stage jet pump 142 further includes a conical member 150 whose narrower end feeds into the diffuser 148. The nozzle 144 is referred to herein as the first nozzle 144, since the two-stage jet pump 142 has two nozzles. The first nozzle 144 injects primary coolant flow (F_{1st.noz}) into the conical member 150. A first suction inlet 152 is defined by a gap between the first nozzle 144 and the conical member 150, and the first nozzle flow (F_{1st.noz}) entrains first suction flow (F_{1st.suct}) drawn from the suction side 46 into the jet pump 142 through the first suction inlet 152. A second nozzle 154 is defined by a conical plenum formed in the conical member 150 and a second suction inlet 156 is defined by a gap between the conical member 150 and the diffuser 148. The second nozzle 154 injects primary coolant flow (F_{2nd.noz}) into the diffuser 148 which entrains second suction flow (F_{2nd.suct}) 1 drawn from the suction side 46, or from a manifold box, into the jet pump 142 through the second suction inlet 156. As best seen in FIG. 12, in the illustrative embodiment two jet pumps 142 are integrally connected by an integral element 160 that includes the conical member 150 for both jet pumps connected together with a common tertiary inlet 162 that feeds the second nozzles 154 of both conical members 150. The toroidal header 70 of the single-stage jet pump embodiment is modified to form a toroidal header 170 that includes central opening 172, outer toroidal plenum 174, and nozzle arms 176 terminating in nozzles 144 (analogous to the corresponding opening 72, toroidal plenum 74, nozzle arms 82, and nozzles 84 of the single-stage embodiment) and further adding a tertiary nozzle arm 178 that feeds into the tertiary inlet 162 of integral element 160 to pressurize the second nozzles 154 of the two jet pumps 142. The toroidal header 170 is also suitably constructed as a main outer housing 180 (analogous to main outer housing 80 of FIG. 5) with an upper bracket 182 and a backplate 190 (analogous to the backplate 90 of FIG. 5). However, in the modified toroidal header 170, the lower bracket 92 mounted on the backplate 90 is replaced by a lower bracket 192 mounted on the main outer housing 80. This arrangement provides room for the tertiary nozzle feed 162, 178.

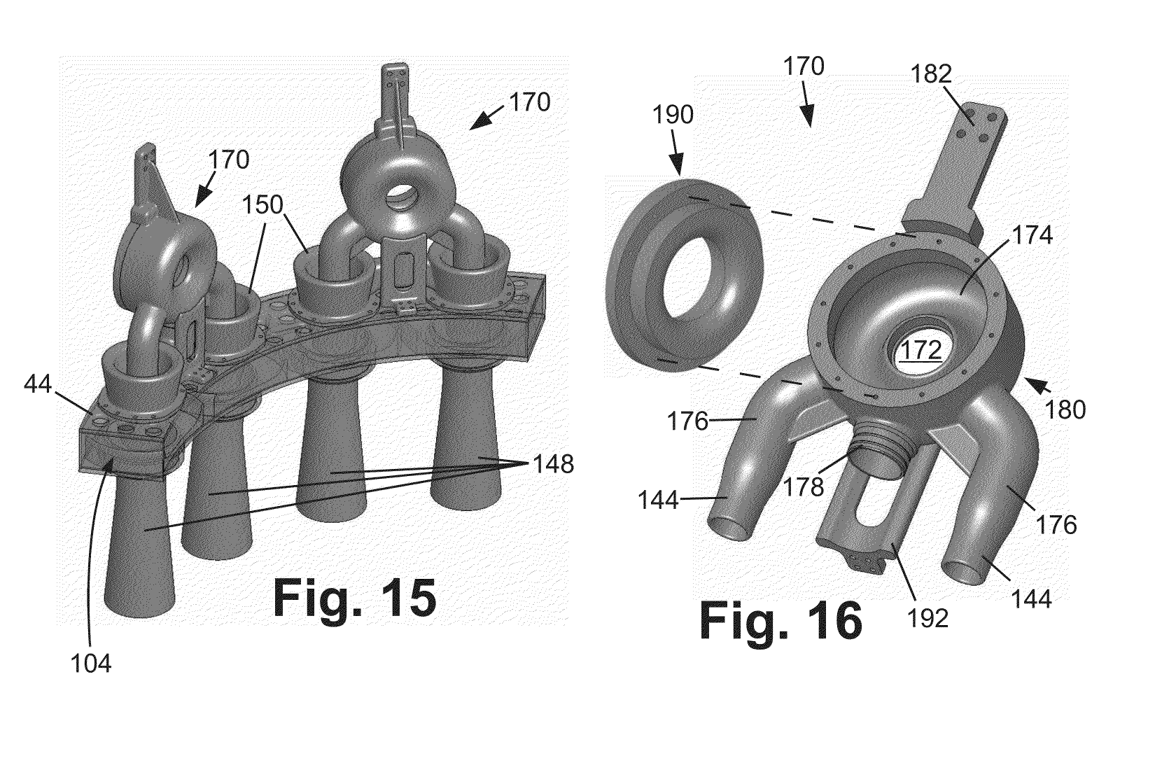

With particular reference to FIGS. 14 and 15 and with further reference back to FIGS. 9 and 10, the same pump plate 44 with its annular flow distribution plenum 104 shown in FIGS. 9 and 10 can be used to mount the two-stage jet pumps 142, although in this case the distribution plenum 104 feeds the second suction inlet 156. In this case the diffuser 148 includes a compression ring 195 for sealing the mounting opening 114. The diffuser 148 is secured to the welded element 120 (see FIG. 10) by the compression ring 195 and optionally by additional fasteners (not shown). The integral element 160 is secured to the top of the pump plate 44 by a flange 192 with the two conical elements 150 disposed in neighboring mounting openings 114.

In operation, the second annular jet (F_{2nd.noz}) is formed around the central nozzle jet (F_{1st.noz}) and first stage suction flow (F_{1st.suct}). The second jet (F_{2nd.noz}) further accelerates the first stage flow (F_{1st.noz}, F_{1st.suct}) and entrains more flow (F_{2nd.suct}) from the secondary suction inlet 156 drawn from inside the annular flow distribution plenum 104. The additional suction flow (F_{2nd.suct}) increases the mass flow ratio thereby requiring less flow outside the reactor vessel (that is, less flow pumped by the hydraulic pump 50) and allowing the hydraulic pump 50 to be designed for a higher pressure head. As is shown in FIGS. 11-16, the second stage is added without major modification to the configuration of the jet pump in the reactor downcomer annulus. The second stage is done with only one additional part (the conical element 150) installed on top of the pump plate 44.

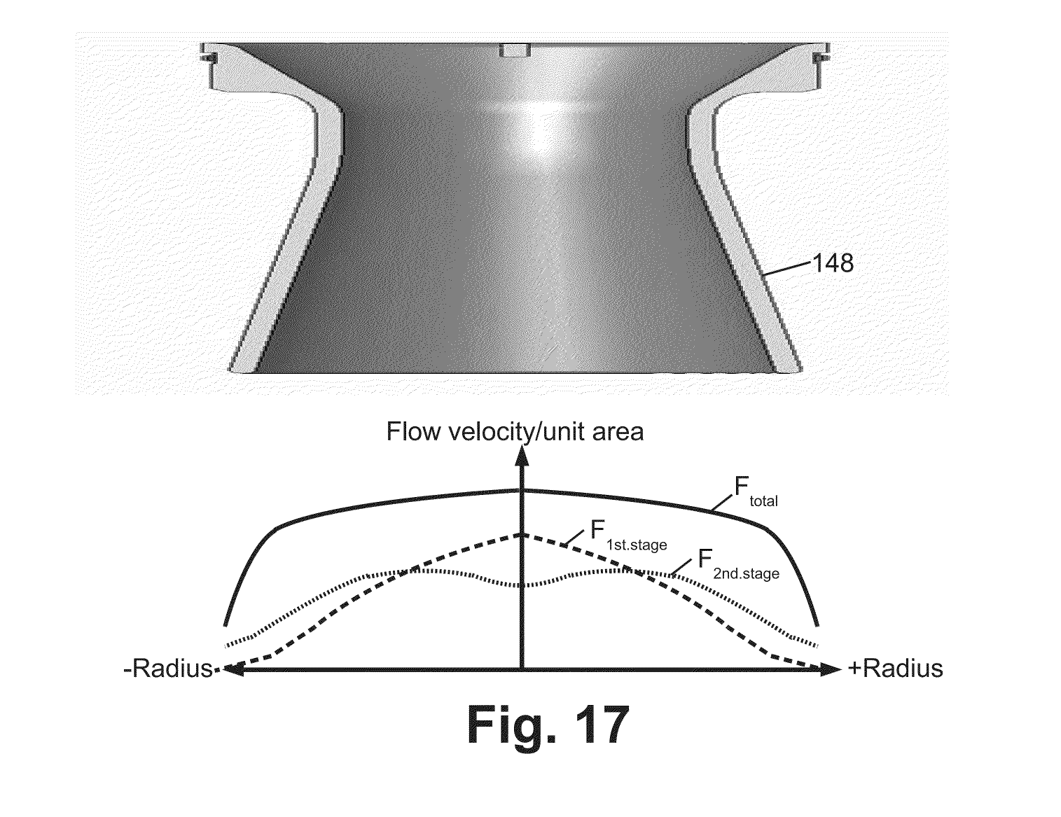

With reference to FIG. 17, a diagrammatic plot of the expected flow density (i.e., flow velocity per unit area) versus radial distance from the centerline of the diffuser 148 is shown for the first stage flow (F_{1st.stage}=F_{1st.noz}+F_{1st.suct}), the second stage flow (F_{2nd.stage}=F_{2nd.noz}+F_{2nd.suct}), and the total flow (Fₜₒₜₐₗ=F_{1st.stage}+F_{2nd.stage}). In general, the first stage flow (F_{1st.stage}) is expected to contribute more strongly to the central flow while the second stage (F_{2nd.stage}) is expected to contribute more to the flow in the periphery (large radial distance). The precise contributions of the four flow components (F_{1st.noz}, F_{1st.suct}, F_{2nd.noz}, F_{2nd.suct}) can be designed using flow modeling, and the availability of four flow components enables the two-stage jet pump 142 to be designed to provide a substantially flat flow velocity.

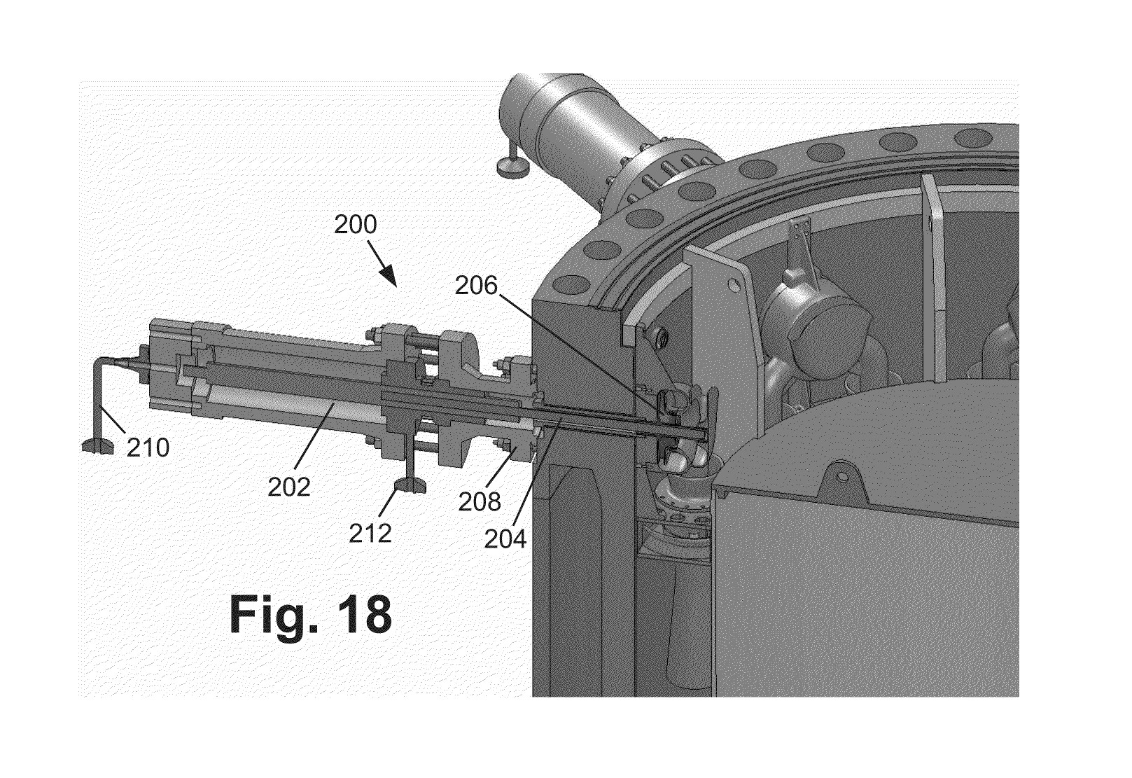

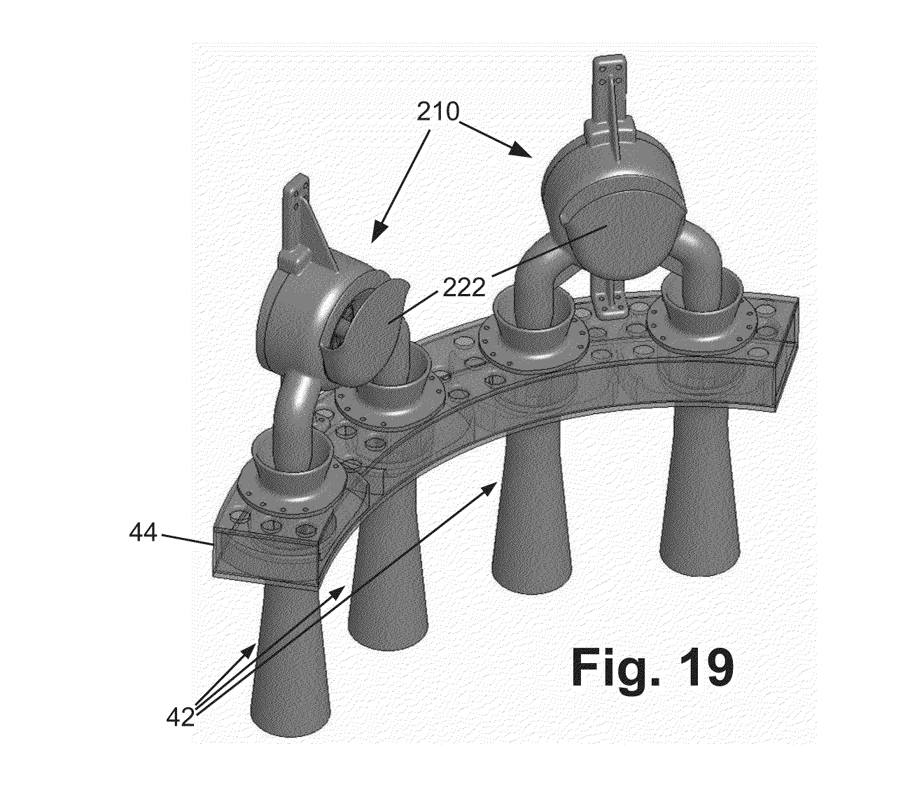

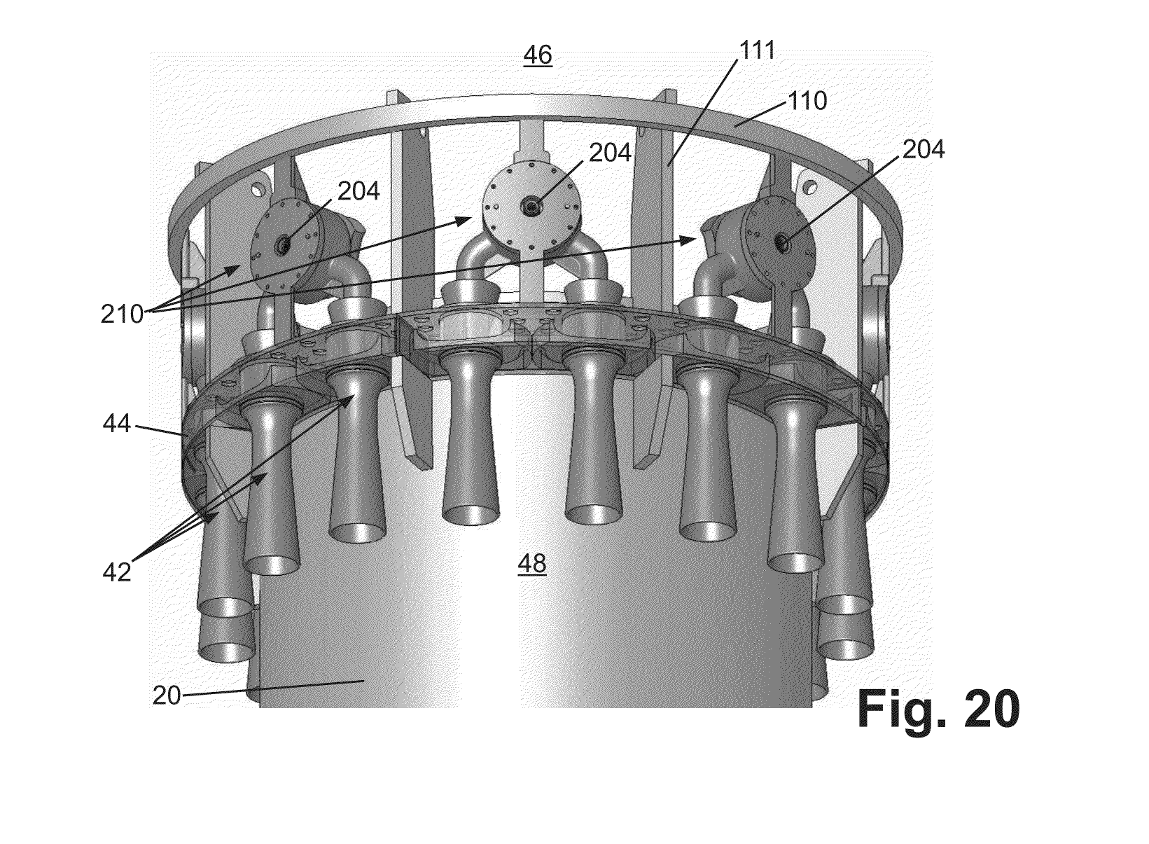

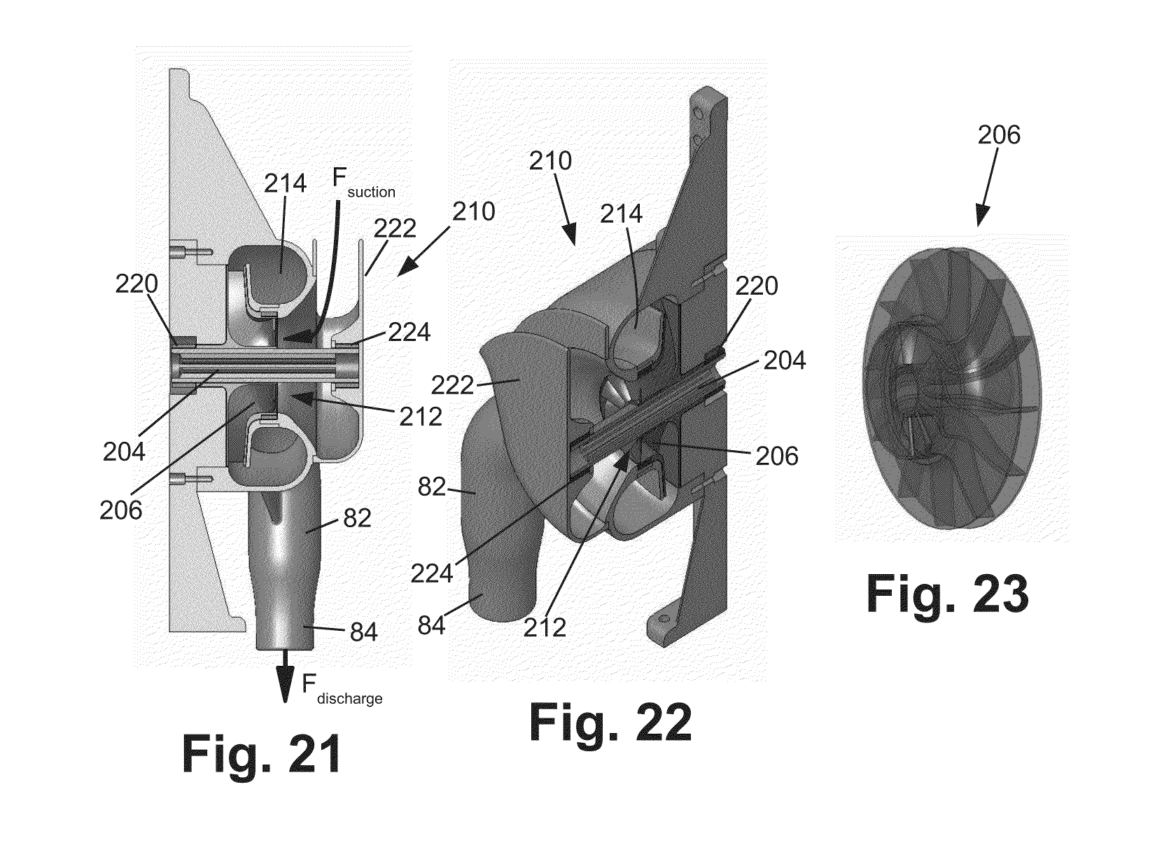

With reference to FIGS. 18-23, a hydraulic pump 200 is shown which can be substituted for the hydraulic pump 50 of FIGS. 2 and 3. The hydraulic pump 200 has a horizontally oriented electric motor 202 and driveshaft 204, and an impeller 206 that is located inside the pressure vessel 12. The electric motor 202 is mounted on the outside of the pressure vessel 12 by a flange 208, and is connected with the impeller 206 by the driveshaft 204 which passes through a penetration of the pressure vessel 12. Coolant lines 210, 212 are optionally provided to provide coolant to the motor 202. In one suitable external motor mounting arrangement, the head of the external hydraulic motor 202 encloses the drive shaft 204 and mounts to a flat milled on the reactor vessel flange forging 208. In this embodiment the coaxial connector 54 is omitted, which (further) reduces the possibility of a small break loss-of-coolant accident (LOCA). FIGS. 19 and 20 show an implementation in which the hydraulic pump 200 is used to pressurize the nozzle 84 of the single-stage jet pump 42. The toroidal header 70 is replaced by a toroidal header 210 that houses the impeller 206. As best seen in FIG. 20, the “input” to the toroidal header is a small-diameter opening through which the driveshaft 204 passes. As best seen in FIGS. 21 and 22, the toroidal header 210 has a central opening 212 that delivers primary coolant to the impeller 206 and an outer toroidal plenum 214 that receives primary coolant discharged by the impeller 206. The outer toroidal plenum 214 is in fluid communication with the nozzle of the jet pump 142 via the nozzle arm 82 so as to pressurize the nozzle 84. To stabilize the distal end of the driveshaft 204 at which the impeller 206 is attached, the toroidal header 210 includes a bearing 220 in the backplate where the driveshaft 204 enters the toroidal housing 210. To further stabilize the distal end of the driveshaft, an inlet hood 222 is optionally disposed over the central opening 212 of the toroidal header 210, and a bearing 224 (which is optionally a thrust bearing) is secured to the inlet hood 222 and bears on the driveshaft 204. In one embodiment of the bearing 224, the drive shaft 204 has splines and mates with splines inside a female collar mounted on the inlet hood 222. The female splined collar has bearings separate from the pump motor bearings to support the loads on the impellor 206. A hollow locking bolt goes through the reactor vessel and screws into the back plate of the centrifugal pump head. The splined drive shaft turns inside the hollow locking bolt. The inlet hood 222 is shaped to define an inlet scoop that helps direct primary coolant into the central opening 212 to the inlet of the impeller 206. With particular reference to FIGS. 21-23, the impeller 206 and its housing formed by the torodial header 210 cooperatively define a centrifugal pump that draws suction flow (F_{suction}) and delivers flow discharge (F_{discharge}) out the nozzle 84 of the jet pump.

With reference back to FIG. 5, the toroidal header 70 is formed as an integral, e.g. cast, part in which the nozzle arms 82 are integrally formed with the toroidal header 70.

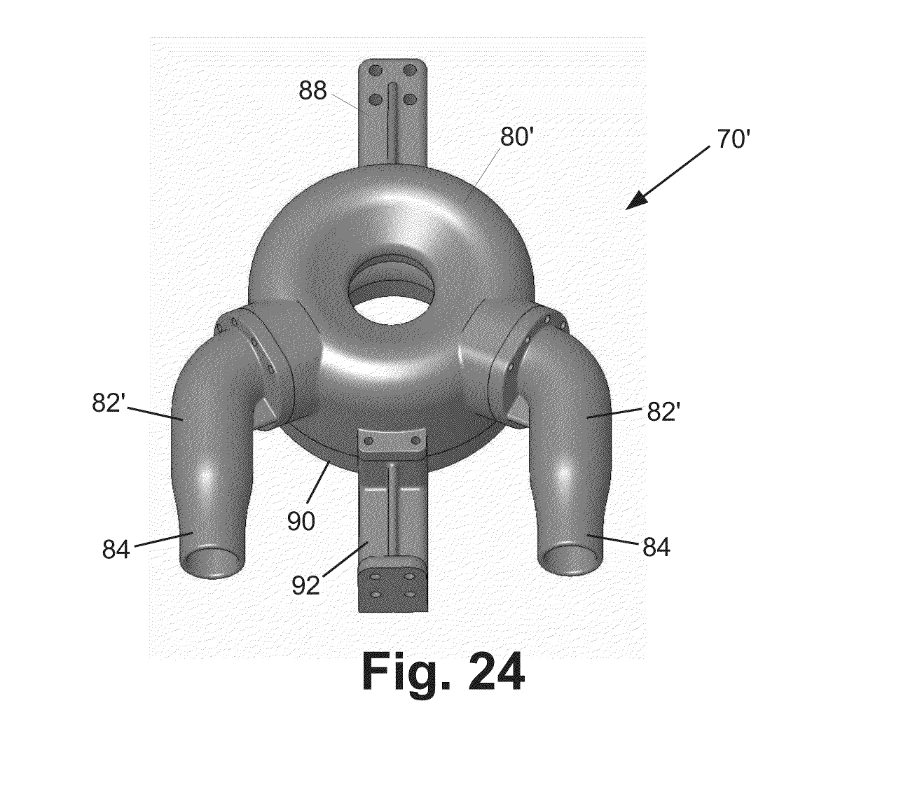

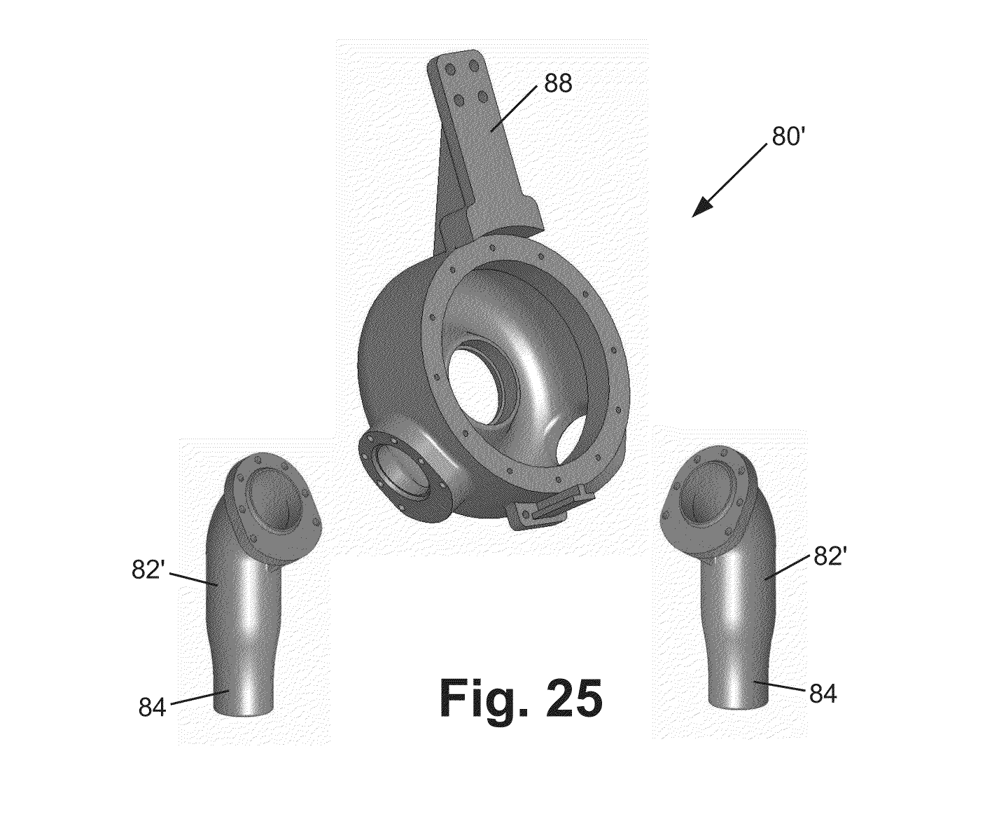

With reference to FIGS. 24 and 25, in an alternative embodiment a toroidal header 70′ has the same form as the toroidal header 70 and includes the same backplate 90 with its lower bracket 92. However, the main outer housing 80 is replaced by a modified main outer housing 80′ having the integral upper bracket 88 as before, but having separately formed nozzle arms 82′ that are attached to the outer housing 80′ by suitable fasteners in order to place the nozzles 84 into fluid communication with the outer toroidal plenum. Thus, the nozzle arms 82′ can be detached form the toroidal header 70′. This separable configuration allows the toroidal header 70′ to be pulled forward toward the centerline of the cylindrical pressure vessel 12. In this way, the external hydraulic pumps 50 need not be removed to service the jet pumps 42. Conversely, the external hydraulic pumps 50 with coaxial header 70′ can be removed without removing the jet pumps 42. In contrast, the integral header 70 could not be pulled forward with the nozzle arms in place because they would be blocked by the conical suction inlets of the jet pumps 42. When using the modified toroidal header 70′, the nozzle arms are first unbolted from the toroidal header 70′ and then are lifted out vertically. The nozzles 84 on the header are short enough that they will clear the conical suction inlets and the maintenance cover plate. This provides sufficient mechanical separation to remove/replace the hydraulic pump 50 without removing the jet pumps 42, or vice versa.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. An apparatus comprising:
An integral pressurized water reactor (PWR) including:
a cylindrical pressure vessel,
a cylindrical central riser disposed coaxially inside the cylindrical pressure vessel wherein a downcomer annulus is defined between the cylindrical central riser and the cylindrical pressure vessel,
a nuclear core comprising a fissile material, and
a steam generator disposed in the downcomer annulus; and
a reactor coolant pump (RCP) including:
a jet pump disposed in the downcomer annulus above or below the steam generator, and
a hydraulic pump configured to pump primary coolant into a nozzle of the jet pump wherein the hydraulic pump includes an electric motor mounted externally on the pressure vessel.

2. The apparatus of claim 1 wherein the hydraulic pump further includes an impeller and the hydraulic pump including the electric motor and the impeller is mounted as a unit externally on the pressure vessel, and the apparatus further comprises:
a coaxial connector having an inner conduit connected with the suction side of the hydraulic pump and an outer conduit surrounding the inner conduit and connecting the discharge side of the hydraulic pump with the nozzle of the jet pump.

3. The apparatus of claim 2, further comprising:
a toroidal header having a central opening delivering primary coolant to the inner conduit of the coaxial connector and an outer toroidal plenum surrounding the central opening and receiving primary coolant discharged from the hydraulic pump through the outer conduit of the coaxial connector wherein the outer toroidal plenum of the toroidal header is in fluid communication with the nozzle of the jet pump.

4. The apparatus of claim 1, wherein the hydraulic pump further includes an impeller disposed inside the pressure vessel and arranged to discharge primary coolant into the nozzle of the jet pump, the impeller being connected with the motor mounted outside the pressure vessel by a driveshaft passing through a penetration of the pressure vessel.

5. The apparatus of claim 4, further comprising:
a toroidal header having a central opening delivering primary coolant to the impeller and an outer toroidal plenum receiving primary coolant discharged by the impeller, the outer toroidal plenum of the toroidal header being in fluid communication with the nozzle of the jet pump.

6. The apparatus of claim 5, further comprising:
an inlet hood disposed over the central opening of the toroidal header; and
a bearing secured to the inlet hood and bearing on the driveshaft.

7. The apparatus of claim 1, further comprising:
an annular pump plate disposed in the downcomer annulus that supports the jet pump and separates the suction and discharge sides of the jet pump.

8. The apparatus of claim 7, wherein the annular pump plate defines an annular flow distribution plenum in fluid communication with the suction side of the jet pump and in fluid communication with a suction inlet of the jet pump.

9. The apparatus of claim 8, wherein the jet pump includes a second suction inlet in fluid communication with the suction side of the jet pump and not in fluid communication with the annular flow distribution plenum.

10. The apparatus of claim 9, wherein the nozzle of the jet pump discharges into a conical inlet of the jet pump and the second suction inlet is defined by an annular gap between the nozzle and the conical inlet of the jet pump.

11. The apparatus of claim 7, wherein the nozzle of the jet pump discharges into a conical inlet of the jet pump and the jet pump includes an annular suction inlet defined between the nozzle and the conical inlet of the jet pump.

12. The apparatus of claim 7, wherein the jet pump is disposed in a pump mounting opening passing through the annular pump plate and the jet pump includes a compression ring compressed between the jet pump and a perimeter of the mounting opening to seal the mounting opening.

13. The apparatus of claim 12, wherein the jet pump is secured to the annular pump plate by fasteners that are accessible from the suction side of the jet pump and is not secured to the annular pump plate by any fasteners that are not accessible from the suction side of the jet pump.

14. The apparatus of claim 1, wherein the jet pump is a single-stage jet pump having a first suction inlet in fluid communication with the suction side of the jet pump and arranged such that primary coolant injected into the jet pump from the nozzle draws primary coolant from the suction side of the jet pump into the first suction inlet.

15. The apparatus of claim 14, wherein the single-stage jet pump also has a second suction inlet different from the first suction inlet, the second suction inlet being in fluid communication with the suction side of the jet pump and arranged such that primary coolant injected into the jet pump from the nozzle draws primary coolant from the suction side of the jet pump into the second suction inlet.

16. The apparatus of claim 1, wherein the jet pump is a two-stage jet pump comprising:
a first stage including a first nozzle and a first suction inlet; and
a second stage including a second nozzle and a second suction inlet;
wherein the hydraulic pump is configured to pump primary coolant into both the first nozzle and the second nozzle;
wherein the first suction inlet is arranged such that primary coolant injected into the jet pump from the first nozzle draws primary coolant from the suction side of the jet pump into the first suction inlet; and
wherein the second suction inlet is arranged such that primary coolant injected into the jet pump from the second nozzle draws primary coolant from the suction side of the jet pump into the second suction inlet.

17. The apparatus of claim 16, wherein the two-stage jet pump includes:
a diffuser; and
a conical member whose narrower end feeds into the diffuser;
wherein the first nozzle injects primary coolant into the conical member and the first suction inlet is defined by a gap between the first nozzle and the conical member;
wherein the second nozzle is defined by a conical plenum formed in the conical member and the second suction inlet is defined by a gap between the conical member and the diffuser.

18. The apparatus of claim 1, further comprising:
a header mounted inside the pressure vessel and including a fluid inlet connected with the suction side of the hydraulic pump and a fluid outlet connected with the discharge side of the hydraulic pump;
wherein the nozzle of the jet pump is rigidly connected with the fluid outlet of the header.

19. The apparatus of claim 18, wherein the header comprises a toroidal header with the fluid inlet being located centrally in the header and the fluid outlet comprising a toroidal plenum surrounding the fluid inlet.

20. The apparatus of claim 19, wherein the nozzle is rigidly connected with the toroidal plenum by removable fasteners.

21. An apparatus comprising:
a reactor coolant pump (RCP) for circulating primary coolant in a pressure vessel of containing a nuclear core comprising a fissile material, the RCP including:
a jet pump configured for mounting inside the pressure vessel, and
a hydraulic pump including an electric motor configured for mounting to the outside of the pressure vessel wherein the hydraulic pump is configured to pump primary coolant into a nozzle of the jet pump.

22. The apparatus of claim 21 wherein the RCP further comprises:
a coaxial connector having an inner conduit connected with the suction side of the hydraulic pump and an outer conduit surrounding the inner conduit and connecting the discharge side of the hydraulic pump with the nozzle of the jet pump.

23. The apparatus of claim 21, wherein the hydraulic pump further includes an impeller and a driveshaft operatively connecting the impeller with the electric motor wherein the driveshaft is configured to pass through the pressure vessel.

24. The apparatus of claim 23, wherein the RCP further comprises:
a toroidal header housing the impeller and guiding primary coolant discharged by the impeller to the nozzle of the jet pump.

25. The apparatus of claim 24, wherein the RCP further comprises:
an inlet hood disposed over the central opening of the toroidal header; and
a bearing secured to the inlet hood and bearing on the driveshaft of the hydraulic pump.

26. The apparatus of claim 21, further comprising:
an annular pump plate to which the jet pump is secured, the annular pump plate being configured to be secured within a downcomer annulus of the pressure vessel.

27. The apparatus of claim 26, wherein the annular pump plate defines an annular flow distribution plenum in fluid communication with a suction inlet of the jet pump.

28. The apparatus of claim 26, wherein the jet pump is secured in a pump mounting opening passing through the annular pump plate with a compression ring compressed between the jet pump and a perimeter of the mounting opening to seal the mounting opening.

29. The apparatus of claim 28, wherein the jet pump is secured to the annular pump plate by fasteners that are accessible from a first side of the annular pump plate and is not secured to the annular pump plate by any fasteners that are not accessible from the first side of the pump plate.

30. The apparatus of claim 21, wherein the jet pump is a two-stage jet pump comprising:
a first stage including a first nozzle and a first suction inlet; and
a second stage including a second nozzle and a second suction inlet;
wherein the hydraulic pump is configured to pump primary coolant into both the first nozzle and the second nozzle;
wherein the first suction inlet is arranged such that primary coolant injected into the jet pump from the first nozzle draws primary coolant into the first suction inlet; and
wherein the second suction inlet is arranged such that primary coolant injected into the jet pump from the second nozzle draws primary coolant into the second suction inlet.

31. The apparatus of claim 30, wherein the two-stage jet pump includes:
a diffuser; and
a conical member whose narrower end feeds into the diffuser;
wherein the first nozzle injects primary coolant into the conical member and the first suction inlet is defined by a gap between the first nozzle and the conical member;
wherein the second nozzle is defined by a conical plenum formed in the conical member and the second suction inlet is defined by a gap between the conical member and the diffuser.

32. An apparatus comprising:
a jet pump; and
an annular pump plate to which the jet pump is secured, the annular pump plate being configured to be secured within a downcomer annulus of a pressure vessel of a nuclear reactor.

33. The apparatus of claim 32, wherein the annular pump plate defines an annular flow distribution plenum in fluid communication with a suction inlet of the jet pump.

34. The apparatus of claim 32, wherein the pump plate includes a mounting opening passing through the annular pump plate and in which the jet pump is secured, the apparatus further comprising:
a compression ring compressed between the jet pump and a perimeter of the mounting opening to seal the mounting opening; and
fasteners securing the jet pump to the annular pump plate wherein the fasteners are accessible from a first side of the annular pump plate;
wherein there are no fasteners securing the jet pump to the annular plate that are not accessible from the first side of the pump plate.
